(19) United States
(12) Patent Application Publication
(10) Pub. No.: US 2016/0192614 A1
(43) Pub. Date: Jul. 7, 2016

(54) Roller carrier

(71) Applicant: Gen 7, Inc., Elverson, PA (US)

(72) Inventors: T. Daniel Hawk, Birdsboro, PA (US); Chao Hsi Lin, Taipei (TW)

(21) Appl. No.: 14/544,410

(22) Filed: Jan. 2, 2015

(51) Int. Cl. A01K 1/02; A45C 13/26; A45C 5/14

(52) U.S. Cl. CPC A01K 1/0236; A45C 5/14; A45C 13/262; A45C 2013/267

(57) ABSTRACT

A carrier structure includes a lower platform substantially parallel to a ground surface upon which the carrier is placed and moved; a back wall connected to a back edge of the lower platform at a connection structure, the back wall and lower platform defining a first angle; a front wall connected to a front edge of the lower platform and opposing the back structure; opposing side walls connected to opposing side edges of the lower platform, the back, front and opposing side walls forming a compartment; wherein the back wall is tiltable away from the front wall to define a second, obtuse angle, between the back wall and the lower platform, such that the lower platform is configured to remain substantially parallel to the ground surface.

### FIELD OF THE INVENTION

The present invention relates to portable carriers, and more specifically to improved portable roller carriers for domestic pets and the like.

### BACKGROUND OF THE INVENTION

Roller carriers include roller structures such as wheels to facilitate movement of the carriers over a surface such as a floor, a sidewalk, through an airport, etc. They may be used to transport, for example, a domestic pet such as a cat or a dog, during traveling. The roller carrier includes a space within which the pet is placed and may be restrained to ease passage of the pet within groups of people or other pets. Panels with openings such as, for example, mesh or screen openings, may be used to permit fresh air for the pet and to permit the pet to view their surroundings which may reduce stress on the pet.

Enclosing a pet in such a manner ensures the pet, such as a dog, is kept under control and unable to wander or have unwanted interactions with other animals or people including children. For example, a dog may not be able to bite a person while within the roller carrier. A roller carrier would also reduce the chance that others would disturb, bother, or harass the pet such a small child inadvertently pulling or tugging a dog's or cat's ears. Roller carriers may resemble suitcases having an extendable handle, or the like, to pull them behind one during movement. They also may be used in places that allow pets, for example, in a store or an airport, so that the pet may be restrained or kept within the carrier. However, when the handle is extended and the carrier is tilted to follow the owner, the floor of the pet compartment also tilts which may startle the pet and cause the pet to suddenly stumble, fall or slip that may also upset the pet, and may harm or injure the pet. At the least, the pet would not appreciate the sudden and disorienting movements.

It is an object of the present invention to provide an improved roller carrier, and methods of using the improved roller carrier structure.

Other objects may appear hereafter.

### SUMMARY OF THE INVENTION

The present invention seeks to provide an improved roller carrier used with, for example, domestic pets, and methods of using the improved roller carrier.

In one exemplary embodiment of the present invention, a carrier structure includes a lower platform substantially parallel to a ground surface upon which the carrier is placed and moved; a back wall connected to a back edge of the lower platform at a connection structure, the back wall and lower platform defining a first angle; a front wall connected to a front edge of the lower platform and opposing the back structure; opposing side walls connected to opposing side edges of the lower platform, the back, front and opposing side walls forming a compartment; wherein the back wall is tiltable away from the front wall to define a second, obtuse angle, between the back wall and the lower platform, such that the lower platform is configured to remain substantially parallel to the ground surface.

In another exemplary embodiment of the present invention A method of using a carrier structure, comprising the steps of: a) placing an object on a lower platform within a compartment of a carrier structure, the lower platform being substantially parallel to a ground surface over which the carrier is placed, the interior space defined by 1) the lower platform, and 2) i) a back wall, ii) a front wall opposing the back wall, and iii) two opposing side walls, each extending up from respective edges of the lower platform; b) tilting the carrier towards a user wherein the back wall tilts towards the user and away from the front wall, the back wall and lower platform defining an obtuse angle, the tilting of the carrier defines a tilted configuration; c) moving the carrier over the ground surface while in the tilted configuration; and d) maintaining the lower platform in a position substantially parallel to the ground surface during movement of the carrier while in the tilted configuration.

In another exemplary embodiment of the present invention, in a carrier having an interior space defined by a) a lower platform, and b) front, rear and opposing side walls rising up from the lower platform; the carrier being configured to contain an object within the interior space and resting on the lower platform; and the carrier being configured to tilt towards a user when moved over a ground surface, the improvement comprising: connecting a back edge of the lower platform to a lower edge of the back wall at an articulating structure such that the lower platform remains substantially parallel to the ground surface during the tilting of the back wall of the carrier towards a user during movement of the carrier across the ground surface.

### BRIEF DESCRIPTION OF THE DRAWINGS

The present invention will be more clearly understood from the following description taken in conjunction with the accompanying drawings in which like reference numerals designate similar or corresponding elements, regions and portions and in which:

FIG. 1 is a schematic, perspective view of a conventional roller carrier and pet compartment;

FIG. 2 is a schematic side view of a roller carrier in use in accordance with an exemplary embodiment of the present invention;

FIGS. 3A-3B are respective schematic perspective views of a skeleton of a roller carrier in an upright position and a tilted position in accordance with an exemplary embodiment of the present invention;

FIGS. 4A-4B are respective schematic perspective views of a skeleton of a roller carrier in an upright position and a tilted position in accordance with another exemplary embodiment of the present invention;

FIGS. 5A-5B are perspective, bottom views of a roller carrier in accordance with another exemplary embodiment of the present invention;

FIG. 6 is a perspective, bottom view of a roller carrier in accordance with another exemplary embodiment of the present invention;

FIG. 7 is a perspective view of the front of a roller carrier and pet compartment in accordance with an exemplary embodiment of the present invention;

FIG. 8 is a perspective, view of the back of a roller carrier in accordance with another exemplary embodiment of the present invention;

FIGS. 9A-9B are back views of a roller carrier in accordance with an exemplary embodiment of the present invention; and

FIG. 10 is a schematic side view of a roller carrier in use in accordance with another exemplary embodiment of the present invention.

### DETAILED DESCRIPTION OF THE PREFERRED EMBODIMENT

The term “about” when referring to a numerical range or value is a convenience and is to be interpreted as plus or minus 10% of that value or range. For example “from about 100 to 1000” is to be interpreted as within the range of 90 to 1100 and “about 1000” is to be interpreted as from 900 to 1100.

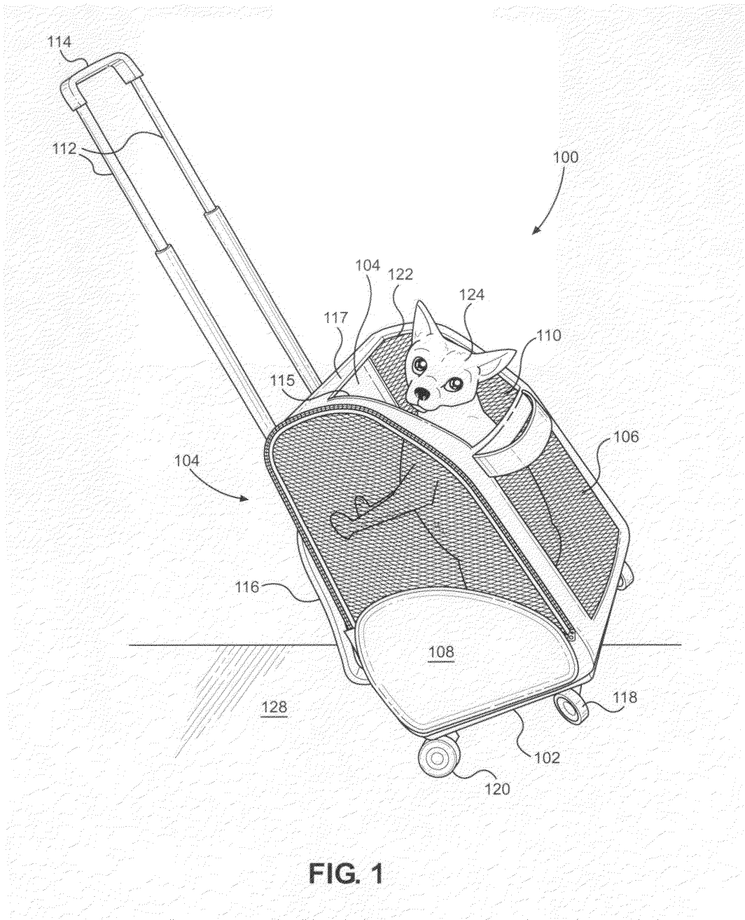

Conventional pet carrier 100 is illustrated in FIG. 1. Conventional pet carrier 100 includes lower platform 102, back wall 104, opposing front wall 106, opposing sidewalls 108, 110, and upper portion 117, all defining compartment 115 within which pet 124 is placed. Such pet carrier 100 may be preferred over using a leash or body harness for the pet during travel or when in crowded locations as pet 124 may be restrained within compartment 115 and away from other animals or pets, small children and others. Although not shown, a removable covering may be placed over opening 122 to further restrain and separate pet 124 from the proximate environment. Handle 114 attached to retractable/extendable handle shafts 112 affixed to back wall 104 may be used to tilt carrier 100 as shown in FIG. 1 to facilitate movement of carrier 100 over ground surface 128. Wheels/rollers 118, 120 are affixed to lower platform 102 so that carrier 100 may roll across surface 128. Carrier 100 may also include shoulder straps 116 affixed to, for example, back wall 104 so that carrier 100 may be carried by a user over their shoulders with, preferable, handle 114/shafts 112 are retracted. However, when carrier 100 is tilted as shown in FIG. 1, pet 124 would also tilt with lower platform 102 and walls 104 106, 108, 110. As shown, pet 124 may tilt by ‘standing-up’ with its front paws on back wall 104, and its hind paws (unwontedly) urged towards the lower intersection of back wall 104 and lower platform 102. If pet 124 were lying down, it would tend to slide/slide around on lower platform 102. Also, carrier 100 may be tilted at varying angles and from a flat lower platform 102 (parallel to a horizontal surface 128) to a tilted lower platform 102 without notice to restrained pet 124. This may cause pet 124 to be jostled within carrier 100 leading to undue stress and exertion of pet 124, and even possible injury. Any pet would also likely not to be able to rest while within carrier 100.

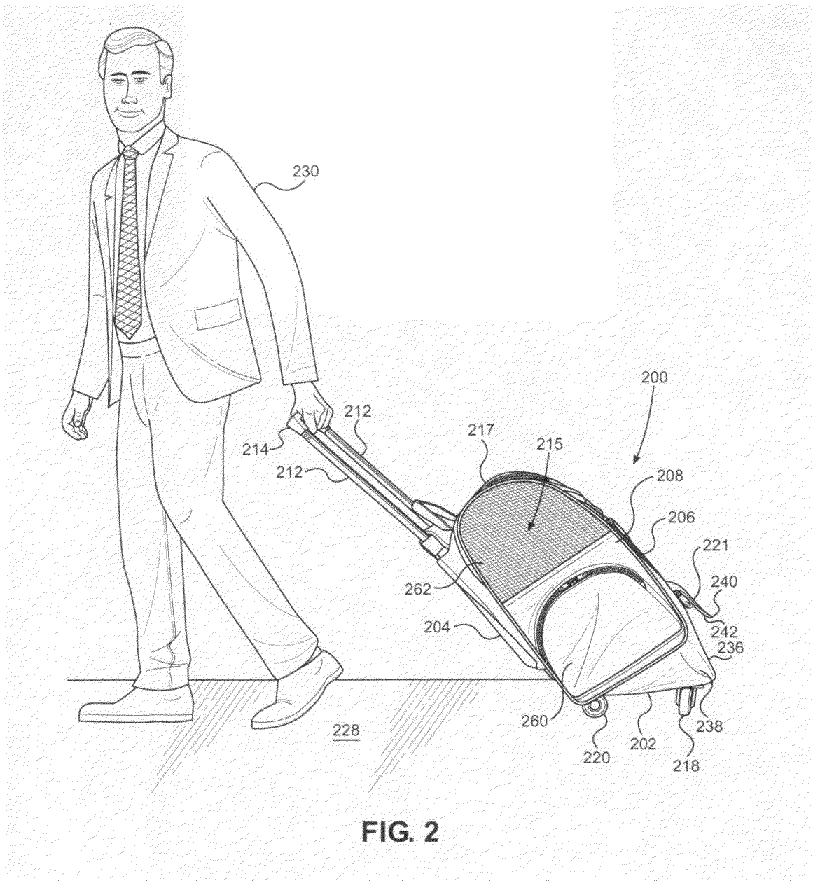

As illustrated in FIG. 2, in an exemplary embodiment of the present invention, carrier structure 200 has lower platform 202, back wall 204, opposing front wall 206, opposing sidewalls 208, 210 (sidewall 210 not shown in FIG. 2), and upper portion 217, all defining compartment 215 within which a pet (not shown in FIG. 2) is placed. Carrier 200 is illustrated being pulled along ground surface 228 by user 230 and as such back wall 204 is tilted by user holding handle 214 along retractable/extendable handle shafts 212 affixed to/comprising part of back wall 204. However, lower platform 202, upon which a pet (or other object) may be placed remains substantially parallel to ground surface 228 and generally undisturbed. By so remaining parallel to ground surface 228, any pet within compartment 215 resting/lying/standing on lower platform 202 is may retain its balance and may remain in its posture prior to the tilting of carrier back wall 204, et al. during the movement shown in FIG. 2. It is noted that ground surface 228 may include sloped surfaces, such as ramps or slopes, and may be a paved, concrete, cement, grass, dirt, etc., surface. Ground surface 228 may also be an uneven surface.

When tilted as shown in FIG. 2, extendible and collapsible material portions 236, 238 comprising lower side portions 238 of respective side walls 208, 210 and excess material front portion 236 on the lower portion of front wall 206 extend, and accommodate the otherwise tilting movement of carrier 200 relative to, and while lower platform 202 remains parallel to, ground surface 228. The maximum amount of such tilt relative to ground surface 228 may be limited by the amount of excess material front portion 236 and excess material side portions 238 as once such excess material front and side portions 236, 238 become fully extended/opened/taunt. Any further tilting of back wall 204 by handle/telescoping shafts 212 (or by other means) would lift front wheels 218 from ground surface 228 and balance carrier 200 on rear wheels 220.

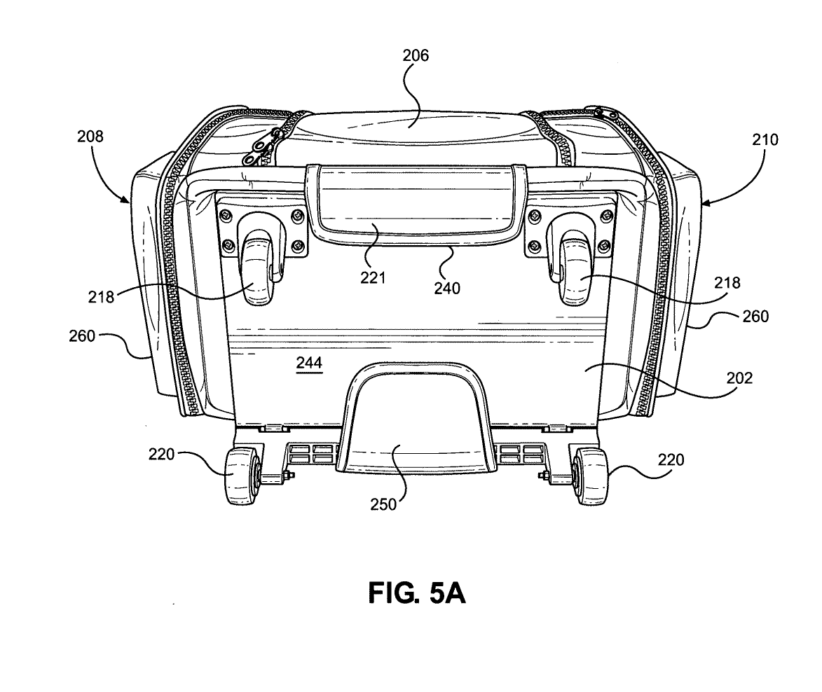

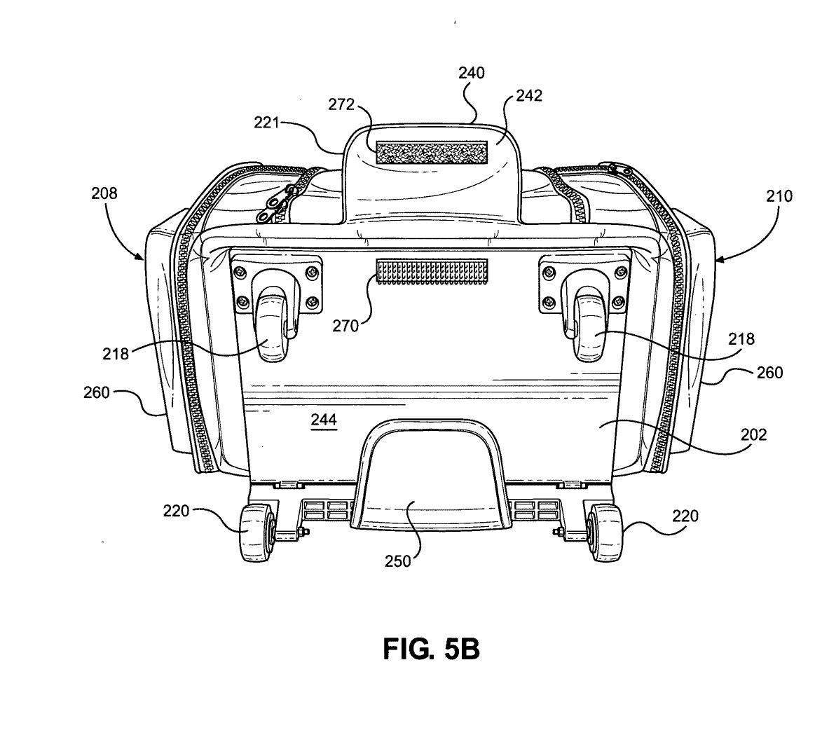

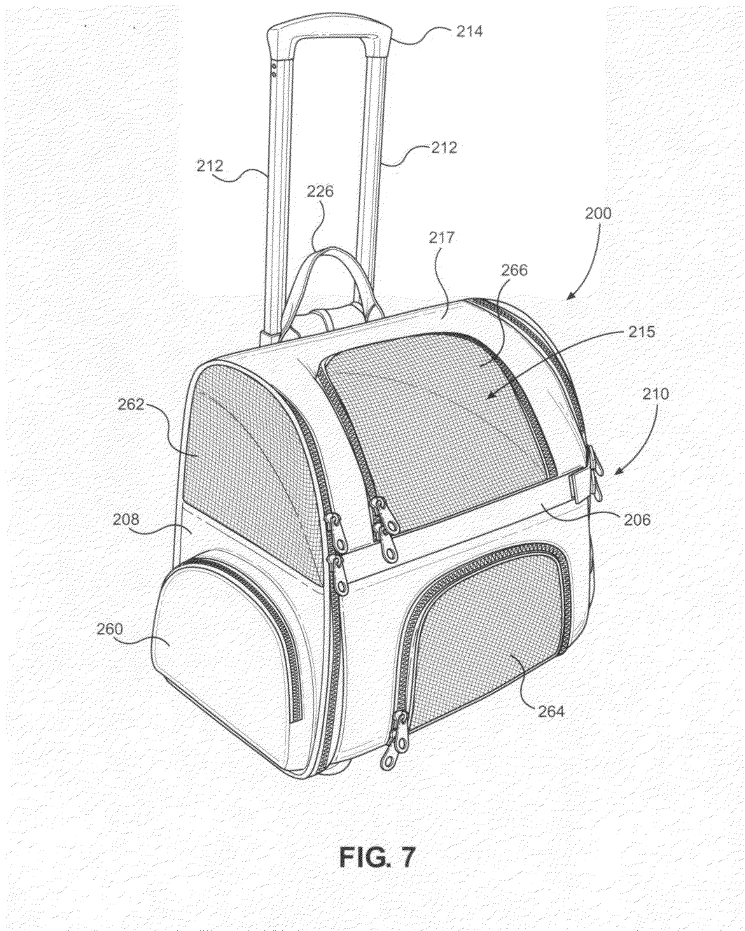

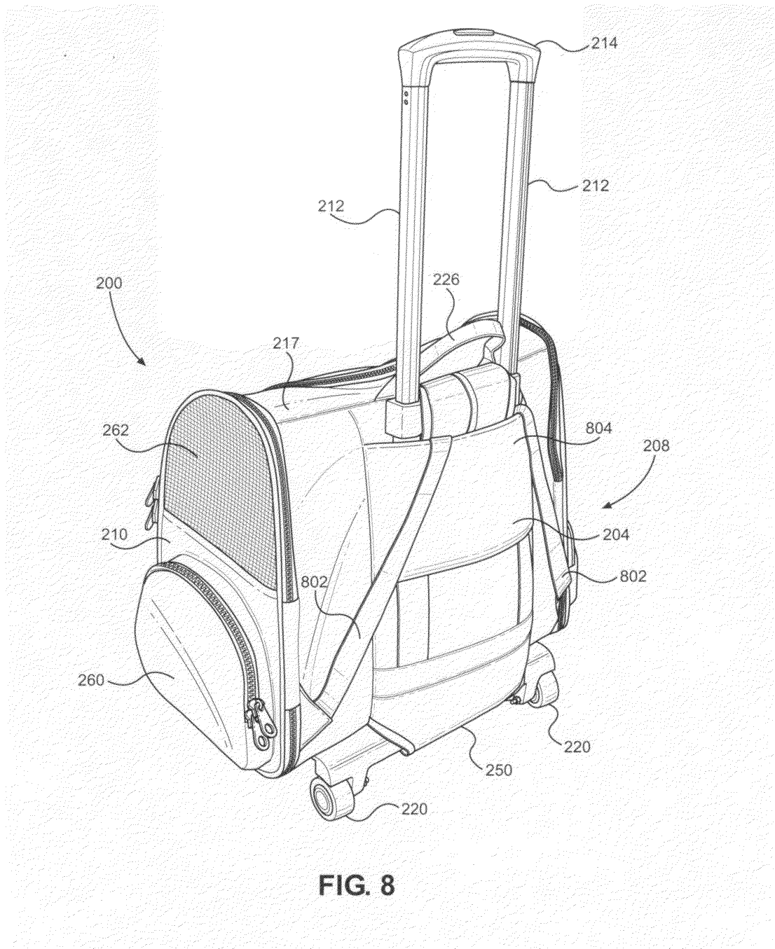

FIG. 7 illustrates carrier 200 in a non-tilted, ‘resting’ configuration, with FIG. 8 illustrating a back perspective view of ‘resting’ carrier 200. Carrier 200 may be maintained in a non-tilted, or resting position (FIG. 7) through the use of an attachment structure such as front attachment tongue 221 affixed to the lower portion of front wall 206 above excess material front portion 236 (see, e.g., FIG. 2, and FIGS. 5A-5B). At the resting position, excess material portions 236, 238 may collapse, or fold, up between respective front and side walls 206; 208, 210 and lower platform 202, and may be essentially unseen as shown in FIGS. 7 and 8, for example, and don't interfere with wheels 218, 220. Free end 240 of tongue 221 is sized to wrap under bottom surface 244 of lower platform 202 (see, e.g., FIGS. 5A-5B). Snap fasteners are also known as press studs, poppers, snaps or tiches. Also a zipper (not shown) may be affixed to tongue free end 240 and the corresponding portion of bottom surface 244 of lower platform 202. Other reversibly fastening structures may include, for example: one or more buttons/buttonholes; buttons/fabric or thread loops; etc. Other reversibly fastening structures are contemplated and are not limited by the examples described herein. For example, as discussed above, a hook and loop attachment structures 270, 272 (e.g., using Velcro® material) positioned on interior side 242 of tongue 221 (see, e.g., FIGS. 2 and 5B) and on the front of bottom surface 244 of lower platform 202 would removably affix free end 240 of tongue 221 to that portion of the front of bottom surface 244 of lower platform 202. When tongue 221 is so affixed to lower platform bottom surface 244, lower platform 202 would tilt with back wall 204 upon any tilting of carrier 200. It is also contemplated that other attachment structures may be used to prevent the tilting of carrier structure 200 relative to ground surface 228/lower platform 202.

As also illustrated in FIGS. 5A-5B, opposing back attachment tongue 250 attached to bottom surface 244 proximate back wall 204 of lower platform 202 may be used to assist in attaching back wall 204 to lower platform 202. FIG. 5B illustrates bottom surface 244 of lower platform 202 with free end 240 of tongue 221 separated from corresponding Velcro® portion affixed to bottom surface 244.

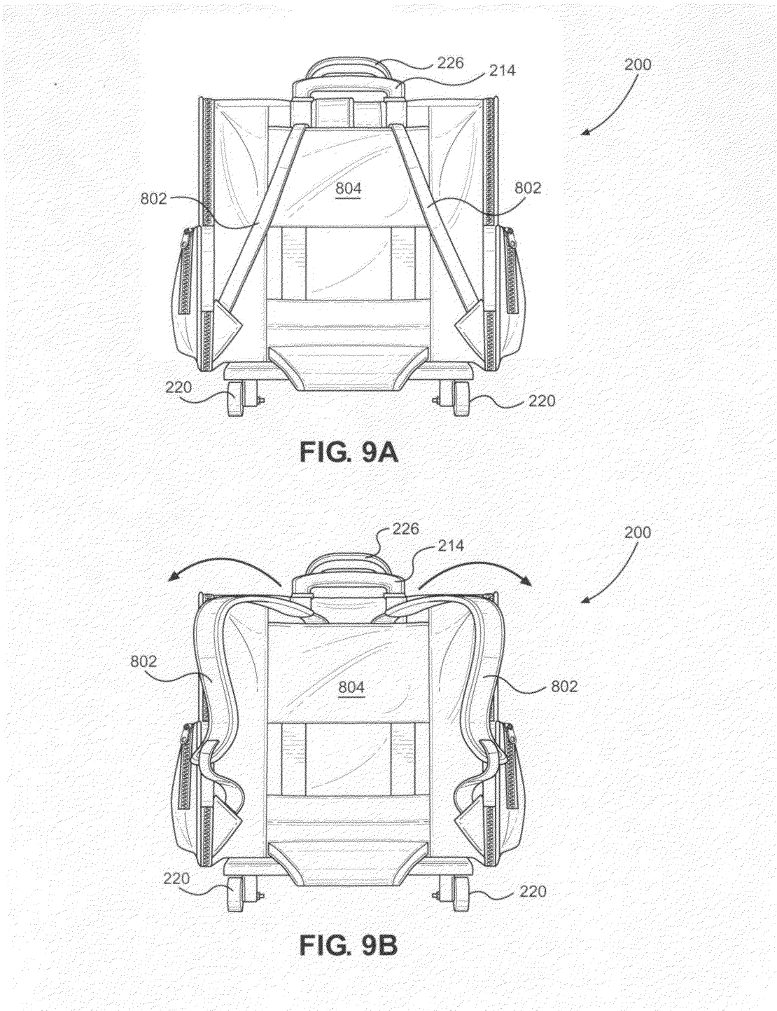

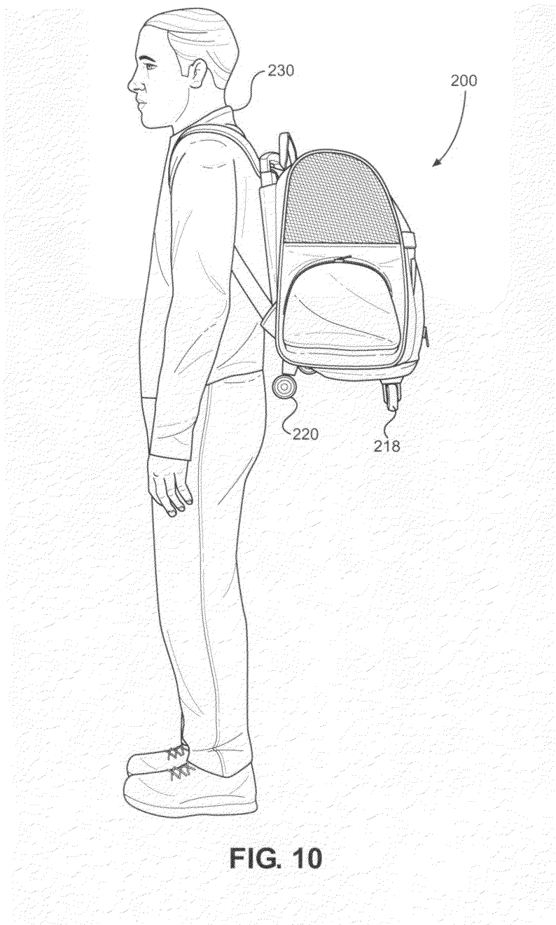

Carrier 200 may also include various storage pockets and openings accessing compartment 215. As shown in FIGS. 2, 5A, 5B, 6-8, and 9A-9B for example, such pockets and openings may include zippered side pockets 260 formed on respective side walls 208, 210; zippered side openings 262 accessing compartment 215; zippered lower front opening 264; and zippered upper opening 266 accessing compartment 215. Other attachment structures may be used to access side pockets 260/compartment 215 such as, for example, and not limited to, snap fasteners, buttons, fabric ties, etc. FIG. 8 illustrates the excess of shoulder straps 802 contained within pocket 804 when not carried on, for example, the back or shoulder, by user 230 as illustrated in FIG. 10. This avoids having the excess shoulder strap material from dragging on the ground, getting tangled in the wheels, etc. FIGS. 9A-9B illustrate the shoulder straps contained within pocket 804 (see, e.g., FIG. 9A) and withdrawn from pocket 804 (see, e.g., FIG. 9B) so that carrier 200 may be carrier on the shoulder/shoulders of user 230 as illustrated in FIG. 10.

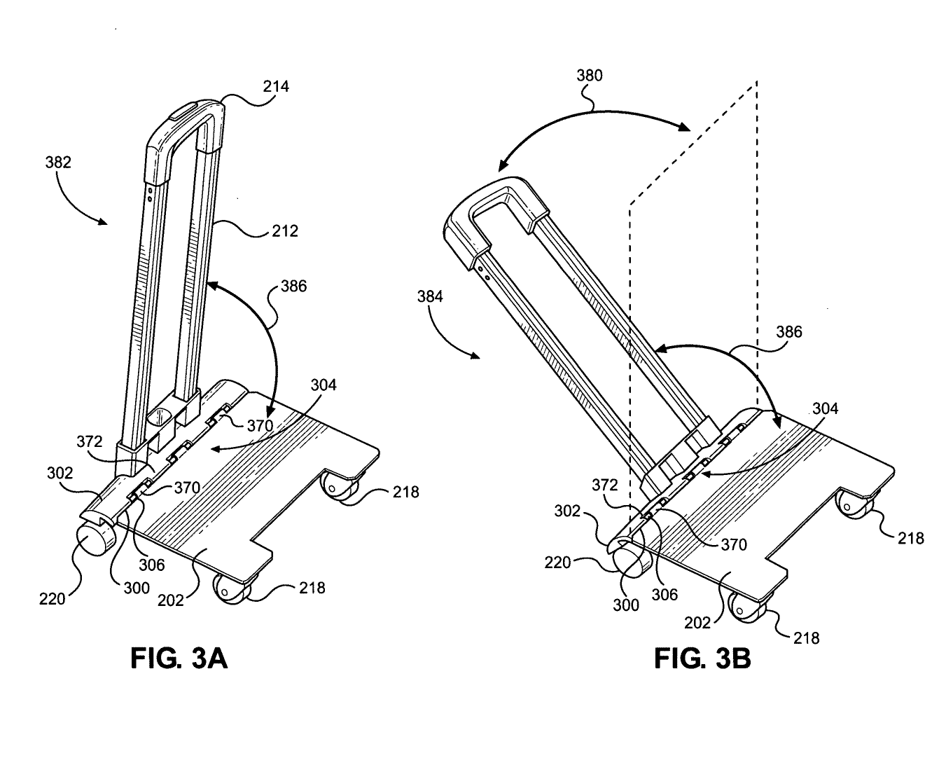

FIGS. 3A-3B illustrate an exemplary embodiment of the present invention of the tilting structure. Specifically, back edge 300 of lower platform 202 is attached to lower back bar 302 of back wall 204 by a connection, or articulating, structure such as, for example, hinge structure 304 formed on each of lower platform back edge 300, and lower back bar 302, with hinge structure rod 306. That is, interlocking tongue portions 370, 372 of lower platform and lower back bar 302, respectively, each include openings within which rod 306 is inserted to restrain tongue portions 370, 372, and thus lower platform 202, lower back bar 302/back wall 204, respectively. Shafts 212, ending in handle 214, are affixed to, and extend upwardly from, lower back bar 302. Hinge structure rod 306, which may be formed of metal or another rigid and strong material, permits relative rotation, or tilting, 380 (see, e.g., FIG. 3B) of lower back bar 302/shafts 212/back wall 204 relative to lower platform 202 from an essentially upright position 382 of shafts 212/back wall 204 (see, e.g., FIG. 3A) to a tilted position 384 (see, e.g., FIG. 3B). As discussed above, the maximum tilt of shafts 212/back wall 204 may be defined by the amount of extendible and collapsible side material portions 236 on the lower portions of respective side walls 208, 210, and/or extendible and collapsible front material portions 236 on the lower portion of front wall 206 (see, e.g., FIG. 2). It is noted that shafts 212/back wall 204 may move relative to lower platform 202, from essentially upright position 382 with an angle of about 90 degrees, to varying tilted positions (otherwise limited to tilted position 384 by excess material side flaps 238, 236) forming an obtuse angle 386 (i.e., greater than 90 degrees but less than 180 degrees) between shafts 212/back wall 204 and lower platform 202. Other hinge structures are contemplated.

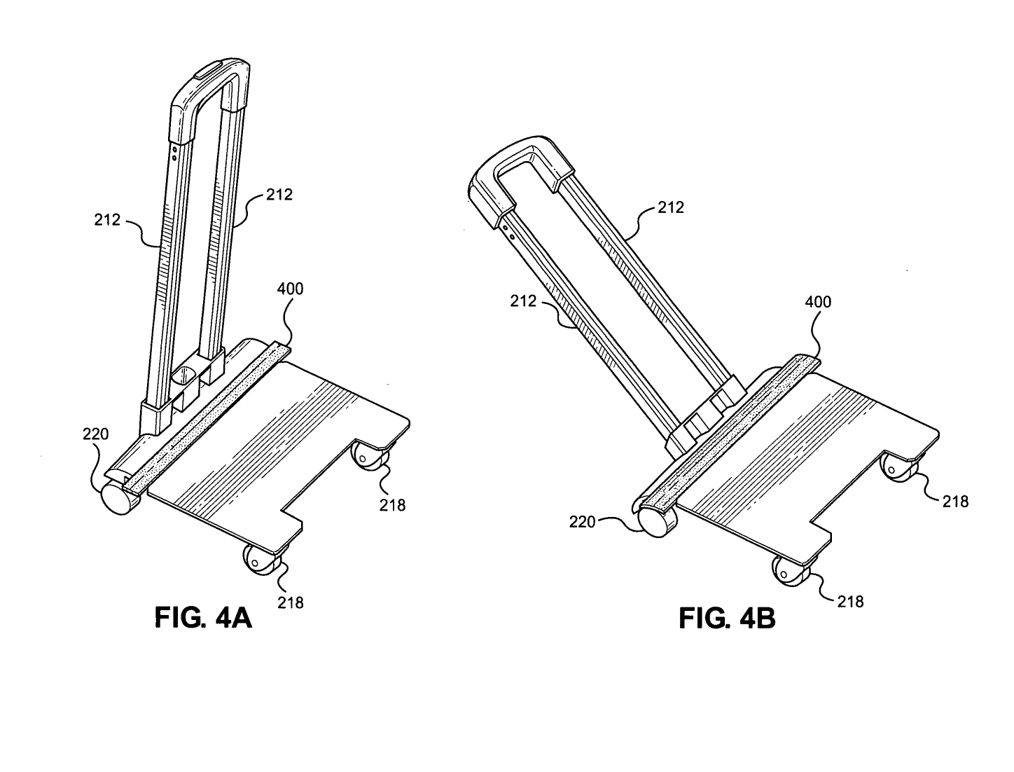

For example, as illustrated in FIGS. 4A-4B in another exemplary embodiment, the lower portion of back wall 204/back edge of lower platform 202 may be formed of a strong but flexible material that may permit tilting of back wall 204 relative to lower platform 202. It is also contemplated that back wall 204/lower back bar 302 are connected by a flexible portion 400. Flexible back wall 204 may extend to and through the back edge of lower platform 202 such that the hinging structure is a single portion of flexible material. Other hinging structures are contemplated and are not limited by the examples described herein. It is noted that when any front attachment structure, such as front attachment tongue 221, is released from bottom surface 244 of lower platform 202, back wall 204 (with side walls 208, 210, front wall 206) may tilt relative to lower platform 202 regardless of whether a pet, or other object, is placed on lower platform 202/within compartment 215.

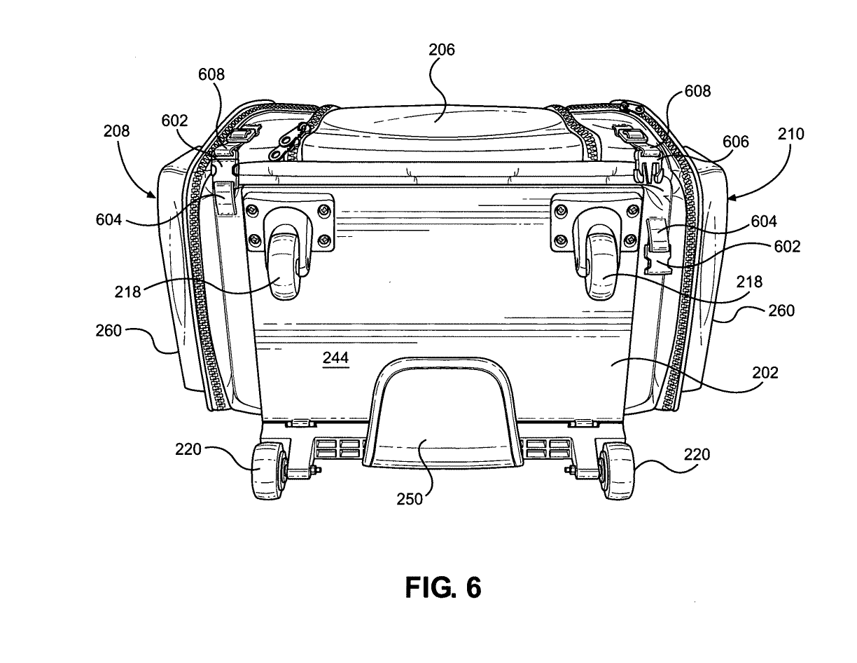

In an exemplary method of using carrier structure 200, a user may place an object, for example a pet cat or dog, on lower platform 202 within interior space/compartment 215 of carrier structure 200 with lower platform 202 being substantially parallel to ground surface 228 over which the carrier is placed. As illustrated in FIGS. 2 and 7, for example, interior space/compartment 215 is defined by 1) lower platform 202, and 2) i) back wall 204, ii) front wall 206, and iii) two opposing side walls 208, 210, each extending up from respective edges of lower platform 202. A user (e.g., user 230 of FIG. 2) may then release tongue 221 otherwise preventing tilting of carrier structure 200 by separating hook and loop structures 270, 272 (see, e.g., FIG. 6) from bottom 244 of lower platform 202. User 230 may then grasp handle 214 and extend it upwardly as necessary and tilt carrier structure 200 towards themselves (see, e.g., FIG. 2) wherein the at least back wall 204 tilts towards user 230 and in a direction away from front wall 206. Such tilting causes back wall 204 and lower platform 202 to define an obtuse angle (e.g., obtuse angle 386 illustrated in FIG. 3B) with tilting of the carrier structure defining a tilted configuration such as that illustrated in FIG. 2. It is noted that such obtuse angle may vary during movement of carrier structure 200 over surface 228 due to the height of user 230, the gait of user 230, the changing slope of surface 228, etc. User 230 is then free to easily move carrier structure 200 over ground surface 228 while in the tilted configuration as illustrated in FIG. 2.

It is noted that wheel structures 220, 218, or the like, may be affixed to bottom surface 244 of lower platform 202 to facilitate movement of carrier structure 200. During movement of carrier structure 200, user 230 maintains lower platform 202 in a position substantially parallel to ground surface 228 during movement of carrier structure 200 while in the tilted configuration illustrated in FIG. 2, for example. It is clear that any pet, for example, placed in compartment 215 and onto lower platform 202 will be moved within carrier structure 200 with lower platform 202 staying substantially parallel to ground surface 228 and so will be more comfortable and less stress during movement. As illustrated in FIG. 2, extendible and collapsible material portions 236, 238 beneath, or extending from the lower surfaces of, respective front wall 206 and sidewalls 208, are extended during tilting of carrier structure 200. When carrier structure 200 is placed back in its upright position (see, e.g., FIGS. 3A and 7), extendible and collapsible material portions 236, 238 collapse, or fold upon themselves, and tongue 221 may be reaffixed to lower surface 244 of lower platform 202 using, for example, hook and loop pair structures 272, 270. It is also contemplated that front wall 206 may include a bump-out, or the like, at the lower portion of front wall 206 to provide greater room above any pet within carrier structure 200 during tilting and tilted movement across surface 228.

While particular embodiments of the present invention have been illustrated and described, it is not intended to limit the invention, except as defined by the following claims.

I claim:

1. A carrier structure comprised of:
a lower platform substantially parallel to a ground surface upon which the carrier is placed and moved;
a back wall connected to a back edge of the lower platform at a connection structure, the back wall and lower platform defining a first angle;
a front wall connected to a front edge of the lower platform and opposing the back structure;
opposing side walls connected to opposing side edges of the lower platform, the back, front and opposing side walls forming a compartment;
wherein the back wall is tiltable away from the front wall to define a second, obtuse angle, between the back wall and the lower platform, such that the lower platform is configured to remain substantially parallel to the ground surface.

2. The carrier structure of claim 1 further comprising an extendable and collapsible material portions of the compartment, the material portion (a) extendable from, and collapsible towards, a front edge of the lower platform away from the back wall, and (b) extendable from, and collapsible towards, side edges of the lower platform when the back wall is tilted away from the front wall to form the second, obtuse angle.

3. The carrier structure of claim 2 further comprising an attachment structure attached to a lower portion of the front structure and to a bottom surface of the lower platform, wherein the attachment structure is reversibly attached to at least one of the lower portion of the front structure and the bottom surface of the lower platform.

4. The carrier structure of claim 3 wherein the attachment structure is detached from at least one of the lower portion of the front structure and the bottom surface of the lower platform when the back wall is tilted away from the front wall to form the second, obtuse angle.

5. The carrier structure of claim 3 wherein the attachment structure includes a hook and loop reversible attachment structure pair.

6. The carrier structure of claim 1 further comprising an overhead covering, wherein upper ends of the back and front walls and the opposing side walls each connect to the overhead covering so that the overhead covering covers the compartment.

7. The carrier structure of claim 1 further comprising an opening in at least one of a) the front and back walls, b) the opposing side walls and c) the overhead covering, the opening permitting access to the compartment.

8. The carrier structure of claim 1 further comprising a handle structure attached to the back wall, the handle structure facilitating the tilting of the back wall.

9. The carrier structure of claim 8 wherein the handle structure is extendable and retractable in relation to the lower platform.

10. The carrier structure of claim 1 wherein the connection structure is a hinged structure.

11. The carrier structure of claim 1 wherein the connection structure is a flex structure.

12. The carrier structure of claim 7 wherein the flexible structure flexes when the back wall is tilted away from the front wall to form the second, obtuse angle.

13. The carrier structure of claim 1 wherein the compartment is configured to contain an animal.

14. The carrier structure of claim 1 wherein the compartment is configured to contain a domestic pet.

15. The carrier structure of claim 1 further comprising rolling structures affixed to a bottom surface of the lower platform, wherein the rolling structures facilitate movement of the carrier over the ground surface.

16. A method of using a carrier structure, comprising the steps of:
a) placing an object on a lower platform within a compartment of a carrier structure, the lower platform being substantially parallel to a ground surface over which the carrier structure is placed, the interior space defined by 1) the lower platform, and 2) i) a back wall, ii) a front wall opposing the back wall, and iii) two opposing side walls, each extending up from respective edges of the lower platform;
b) tilting the carrier structure towards a user wherein the at least the back wall tilts towards the user and away from the front wall, the back wall and lower platform defining an obtuse angle, the tilting of the carrier structure defines a tilted configuration;
c) moving the carrier structure over the ground surface while in the tilted configuration; and
d) maintaining the lower platform in a position substantially parallel to the ground surface during movement of the carrier structure while in the tilted configuration.

17. The method of claim 16 further comprising the step of detaching an attachment structure at a lower front of the carrier structure before the tilting step.

18. The method of claim 16 wherein during the tilting step, an extendable and collapsible material portion of the compartment, extends to facilitate the tilting of the carrier structure towards a user while maintaining integrity of the compartment, the material portion (a) extendable from a front edge of the lower platform away from the back wall, and (b) extendable from side edges of the lower platform when the back wall is tilted away from the front wall to form the second, obtuse angle in the tilted configuration.

19. In a carrier structure having an interior space defined by a) a lower platform, and b) front, rear and opposing side walls rising up from the lower platform; the carrier structure being configured to contain an object within the interior space and resting on the lower platform; and the carrier structure being configured to tilt towards a user when moved over a ground surface, the improvement comprising: connecting a back edge of the lower platform to a lower edge of the back wall at an articulating structure such that the lower platform remains substantially parallel to the ground surface during the tilting of at least the back wall of the carrier structure towards a user during movement of the carrier structure across the ground surface.

20. The carrier structure of claim 19 wherein an obtuse angle is formed between the lower platform and back wall during the tilting of at least the back wall of the carrier structure towards a user.
